(19) United States
(12) Patent Application Publication
(10) Pub. No.: US 2015/0086207 A1
(43) Pub. Date: Mar. 26, 2015

(54) COMB LASER OPTICAL TRANSMITTER AND ROADM

(71) Applicant: Verizon Patent and Licensing Inc., Basking Ridge, NJ (US)

(72) Inventor: David Z. Chen, Richardson, TX (US)

(73) Assignee: Verizon Patent and Licensing Inc., Basking Ridge, NJ (US)

(21) Appl. No.: 14/036,199

(22) Filed: Sep. 25, 2013

(51) Int. Cl. H04Q 11/00

(52) U.S. Cl. CPC H04Q 11/0005; H04Q 2011/0015
USPC 398/87

(57) ABSTRACT

A device may use a comb laser in dense wavelength division multiplexed transmitter and/or reconfigurable optical add or drop multiplexer. The device may include a comb laser to provide a source beam having a plurality of wavelengths. The device may further include a wavelength separator to create a plurality of beams from the source beam, where the wavelength separator is coupled to the comb laser. Each beam from the plurality of beams is centered at a different wavelength. The device may further include processors coupled to the wavelength separator, where the processors separately process each beam. The device may further include a wavelength combiner which is coupled to the plurality of processors. The wavelength combiner merges the plurality of beams into an output beam having a plurality of wavelengths.

### BACKGROUND INFORMATION

With the proliferation of fiber optic networks and the wider adoption of high-speed networking, the demand for systems using lasers at different wavelengths is increasing. For example, Wavelength Division Multiplexing (WDM), Coarse Wavelength Division Multiplexing (CWDM), and Dense Wavelength Division Multiplexing (DWDM) systems increase data capacity by using multiple channels over a single fiber, where each channel may be associated with a particular wavelength. Different wavelengths may be added or dropped to or from a WDM/CDWM/DWDM signal using a Reconfigurable Optical Add-Drop Multiplexer (ROADM). Transmitters used with such systems may include tunable lasers that are set based on the wavelength of the channel to which they are connected. These tunable lasers can be expensive, and may be susceptible to drifts in wavelength due, for example, to variations in environmental conditions.

### BRIEF DESCRIPTION OF THE DRAWINGS

FIG. 1 is a drawing illustrating an exemplary network in which embodiments described herein may be implemented;

FIGS. 2 is a diagram showing differences between a tunable laser and a comb laser;

FIG. 3 is a block diagram illustrating an exemplary Optical Transmitter and ROADM which uses a comb laser;

FIG. 4 is a block diagram showing exemplary components of the Optical Transmitter and ROADM of FIG. 3;

FIG. 5 is a block diagram illustrating exemplary components including photonic switching for the Optical Transmitter and ROADM of FIG. 3;

FIG. 6 is a block diagram showing exemplary components including variable gain amplifiers for the Optical Transmitter and ROADM of FIG. 3;

FIG. 7 is a block diagram illustrating exemplary components including those used for automatic gain control in the Optical Transmitter and ROADM of FIG. 3;

FIG. 8 is a flowchart showing an exemplary process for the operation of the Optical Transmitter and ROADM of FIG. 3;

FIG. 9 is a flowchart showing an exemplary process for the operation of the automatic gain control for the Optical Transmitter and ROADM of FIG. 7; and

FIG. 10 is a block diagram of an exemplary controller for the Optical Transmitter and ROADM of FIG. 7.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Embodiments provided herein relate to devices and methods implementing a comb laser for use in wavelength division multiplexed environments, such as, for example, CWDM, WDM, DWDM and/or ROADM applications. Coarse wavelength division multiplexing (CWDM), Wavelength division multiplexing (WDM) and dense WDM (DWDM) enable transmission of data signals having a number of different wavelengths into a single optical fiber. The comb laser generates a source beam which covers a range of wavelengths, which may be used to simultaneously provide multiple wavelengths for use in CWDM, WDM or DWDM systems. In an embodiment, the source beam of a comb laser is separated into multiple beams, where each beam may be centered a particular wavelength that may be thought of as separate channel. Upon separation, each beam is individually processed as a separate channel in a parallel manner. The processing includes, for example, separately adjusting the amplitude of each beam to correct wavelength dependent amplitude variations which may be present in the source beam. The processing may also include modulating each beam to encode information within each channel. The processing can further include the adding or dropping of wavelengths through various switching approaches, thus effectively adding or dropping individual channels according to the needs of the optical network. Once the processing of individual beams is complete, the beams may be combined into an output signal, such as, for example, a CDWM, WDM, or DWDM signal.

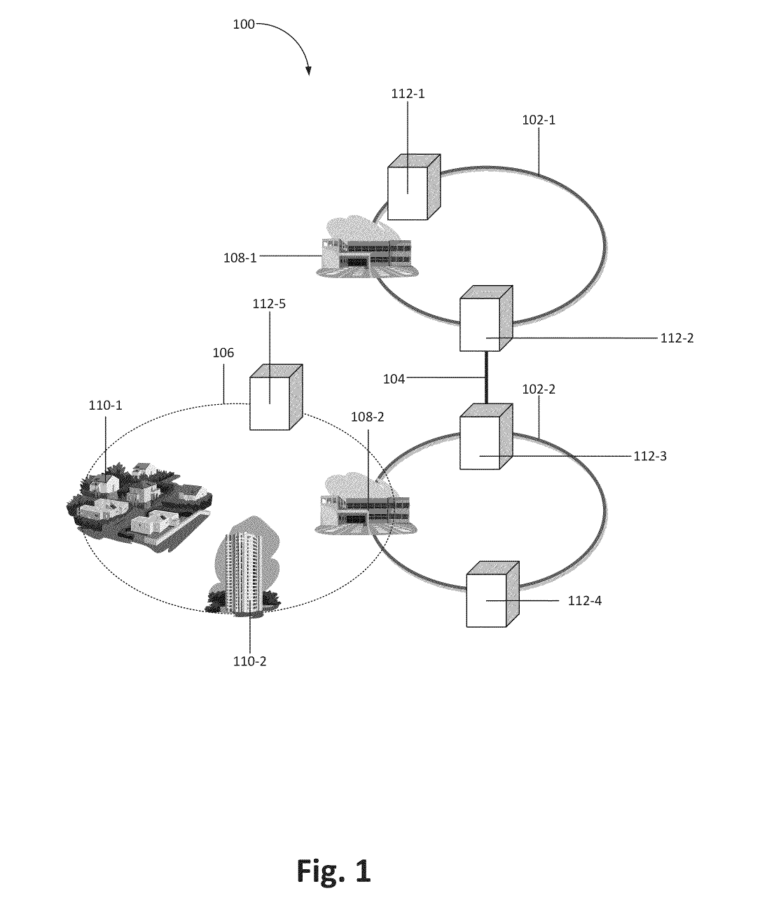

FIG. 1 is a block diagram of an exemplary network 100 in which embodiments described herein may be implemented. As shown, optical network 100 may include metro/regional networks 102-1 and 102-2, long haul or ultra-long haul optical lines 104, and edge network 106. Depending on the implementation, optical network 100 may include may include additional, fewer, or a different configuration of optical networks and optical lines than those illustrated in FIG. 1. For example, in one implementation, optical network 100 may include additional edge networks and/or metro/regional networks that are interconnected by, for example, Synchronous Optical Network (SONET) rings and/or Optical Transport Networks (OTN).

Metro/regional network 102-1 may include optical fibers and central office hubs that are interconnected by the optical fibers. The central office hubs, one of which is illustrated as central office hub 108-1, may include sites that house telecommunication equipment, including switches, optical line terminals, etc. In addition to being connected to other central offices, central office hub 108-1 may provide telecommunication services to subscribers, such as telephone service, access to the Internet, cable television programs, etc., via optical line terminals. Metro/regional network 102-2 may include similar components as metro/regional network 102-1 and may operate similarly. In FIG. 1, metro/regional network 102-2 is illustrated as including central office hub 108-2, which may include similar components as central office hub 108-1 and may operate similarly. Long haul optical lines 104 may include optical fibers that extend from metro/regional optical network 102-1 to metro/regional optical network 102-2.

Edge network 106 may include optical networks that provide user access to metro/regional optical network 102-2. As shown in FIG. 1, edge network 106 may include access points 110-1 and 110-2 (e.g., office buildings, residential area, etc.) via which end customers may obtain communication services from central office hub 108-2.

In FIG. 1, networks 102-1, 102-2, and 106 may include ROADMs 112-1 through 112-5 (collectively “ROADMs 112” and individually “ROADM 112-x”). Each ROADM 112-x may add or drop optical signals of particular wavelengths to/from the network and provide for part of wavelength division multiplexing (WDM) in network 100. The configuration of ROADMs 112 may be controlled remotely (e.g., from central office hub 108-1). In some implementations, data in network 100 may be transmitted using, for example, DWDM, which may use the C band (i.e., frequencies between 1530 and 1565 nanometers (nm)) and/or L band (i.e., wavelengths between 1565 and 1625 nm).

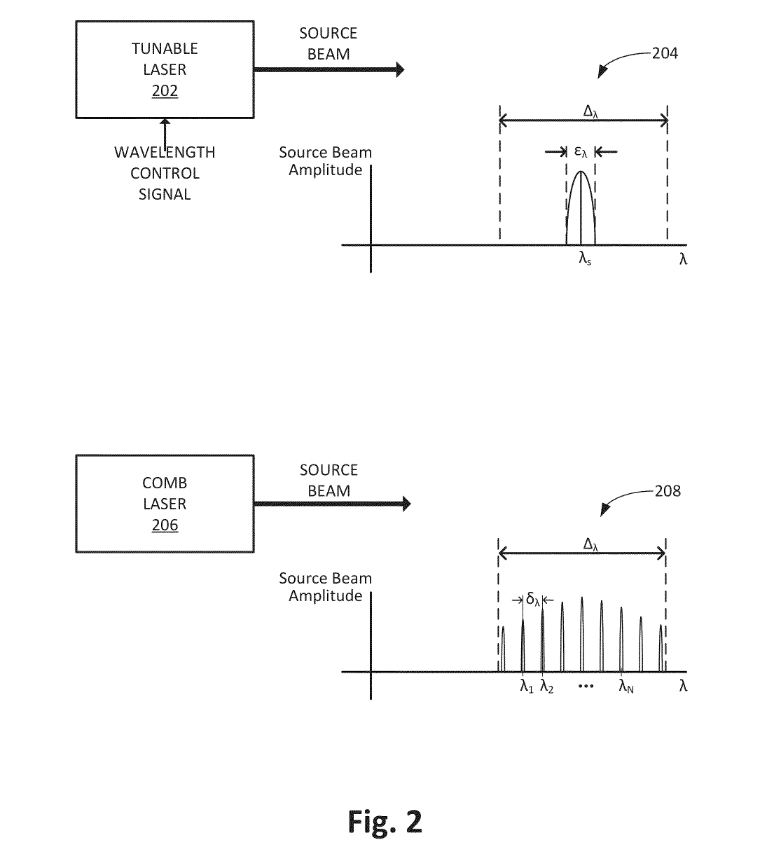

FIG. 2 is a diagram illustrating exemplary differences between tunable laser 202 and comb laser 206. Tunable laser 202 may produce a source beam at a selected wavelength λₛ. As shown in graph 204, which depicts the source beam amplitude versus wavelength λ, the source beam wavelength is “tuned” from a range of wavelengths Δ_{λ} to the selected wavelength λₛ. The range of wavelengths may include parts of C band, parts of L band, or combinations thereof; or the entire C band, the entire L band, or a combination thereof. The tuning of the wavelength may be externally commanded using a wavelength control signal. In practice, tunable laser 202 may tune the wavelength by controlling the physical length of a resonant cavity within the laser. This approach can limit the precision to which tunable laser 202 can select the wavelength. Accordingly, an error ε_{λ} may be associated with a shift in selected wavelength λₛ as shown in graph 204. The error ε_{λ} may be dependent on thermal factors, which can motivate the use of precise temperature controls to reduce the error ε_{λ}. However, such temperature controls can increase the cost and complexity of systems using tunable lasers 202. Additionally, the control of tunable laser 202 is typically realized using circuits, which have components that may drift and introduce additional errors in the selected wavelength λₛ. In practice, the wavelength errors may be compensated using filtering techniques which may reduce the efficiency of the system since filtering discards optical energy.

In contrast, comb laser 206 may produce a source beam which simultaneously includes multiple wavelengths over the range of wavelengths Δ_{λ}. The range of wavelengths may include parts of C band, parts of L band, or combinations thereof; or the entire C band, the entire L band, or combinations thereof. As shown in graph 208, the amplitude of the source beam produced by comb laser 206 may vary as a function of wavelength. However, as will be discussed in detail below, these variations may be addressed using amplitude compensation during processing. Systems using the comb laser 206 may save costs. One comb laser 206 can replace multiple tunable lasers 202, since comb laser 206 produces a beam with multiple wavelengths. For example, as shown in graph 208, comb laser 206 may produce wavelengths λ₁, λ₂, . . . , λ_{N}, where δ_{λ} is the channel spacing. Additionally, comb laser 206 may not require precise thermal control to maintain wavelength accuracy, which results in reduced cost and less complexity. Moreover, systems using comb laser 206 may be more efficient. Instead of discarding unwanted wavelengths via filtering, different wavelengths are simultaneously used in a parallel manner, as will be discussed below in more detail. Finally, systems using comb lasers have the ability to quickly add or drop wavelengths using fast photonic switches. Aspects of systems using comb lasers 206, including exemplary Optical Transmitters and ROADMs, are presented in more detail below.

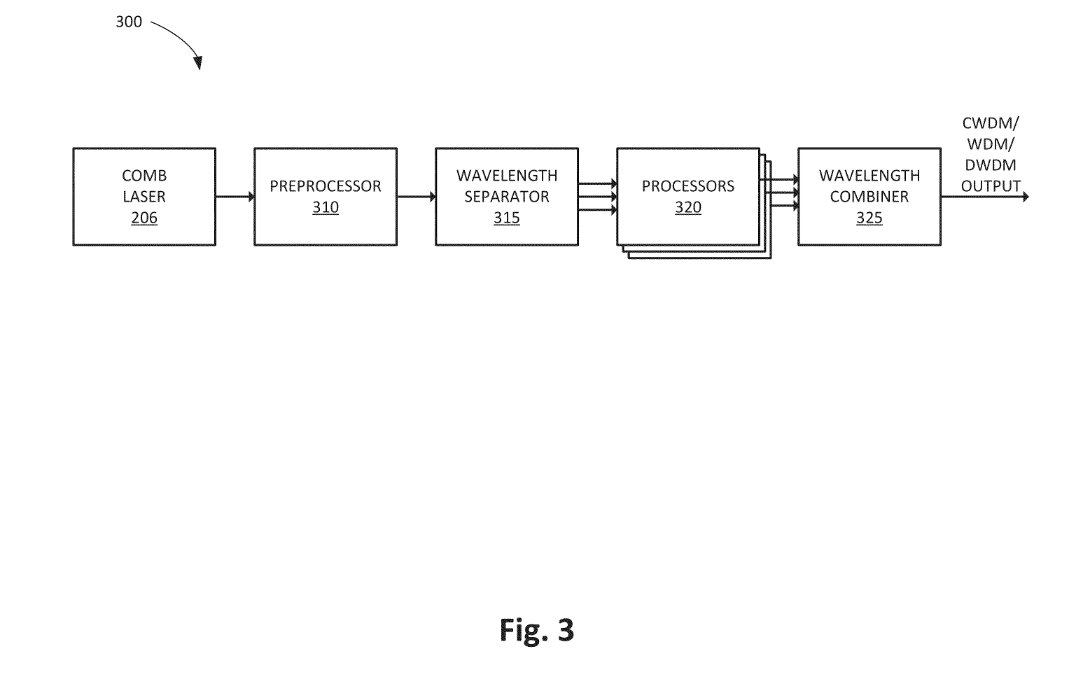

FIG. 3 is a top level block diagram illustrating an exemplary Optical Transmitter and ROADM (Optical Tx/ROADM) 300 according to an embodiment. Components of Optical Tx/ROADM 300 include comb laser 206, preprocessor 310, wavelength separator 315, processors 320, and wavelength combiner 325. These components may be configured in a manner as shown in FIG. 3 and as described below.

The comb laser 206 provides a source beam having multiple wavelengths over a range as described above in relation to FIG. 2. In this manner, a single laser source may provide many wavelengths simultaneously for use in the Optical Tx/ROADM 300. Comb laser 206 may be optically coupled to preprocessor 310, which optically conditions the source beam prior to separating the source beam into multiple beams. The optical conditioning may include any form of optical processing which facilitates the separating process. For example, in an embodiment, preprocessor 310 includes a collimator, which aligns the source beam to improve beam separation. Preprocessor 310 may be optically coupled to wavelength separator 315. Wavelength separator 315 receives the preprocessed source beam and separates it into multiple beams, where each separated beam is centered at a different wavelength λᵢ. Wavelength separator 315 may utilize any known optical components to perform the separation. In one embodiment, wavelength separator 315 uses a diffraction grating. Wavelength separator 315 is optically coupled to processors 320, which receive each of the separated beams corresponding to the different wavelengths, and individually process the beams in a parallel manner. While shown in FIG. 3 as separate entities for clarification, processors 320 may be realized in a single unit which can perform parallel processing of the beams. The processing includes, for example, separately adjusting the amplitude of each beam to correct wavelength dependent amplitude variations, modulating each beam to encode information within each channel, and adding or dropping wavelengths through various switching approaches.

Processors 320 may be optically coupled to wavelength combiner 325, which merges the individually processed beams into a single output signal. Wavelength combiner 325 may include any optical component(s) suitable for merging the individual beams into a single optical beam having multiple wavelengths. In an embodiment, wavelength combiner 325 includes a collimator and a multiplexer to produce a DWDM output beam. As will be described below, the DWDM output beam may be further processed before being used in network 100.

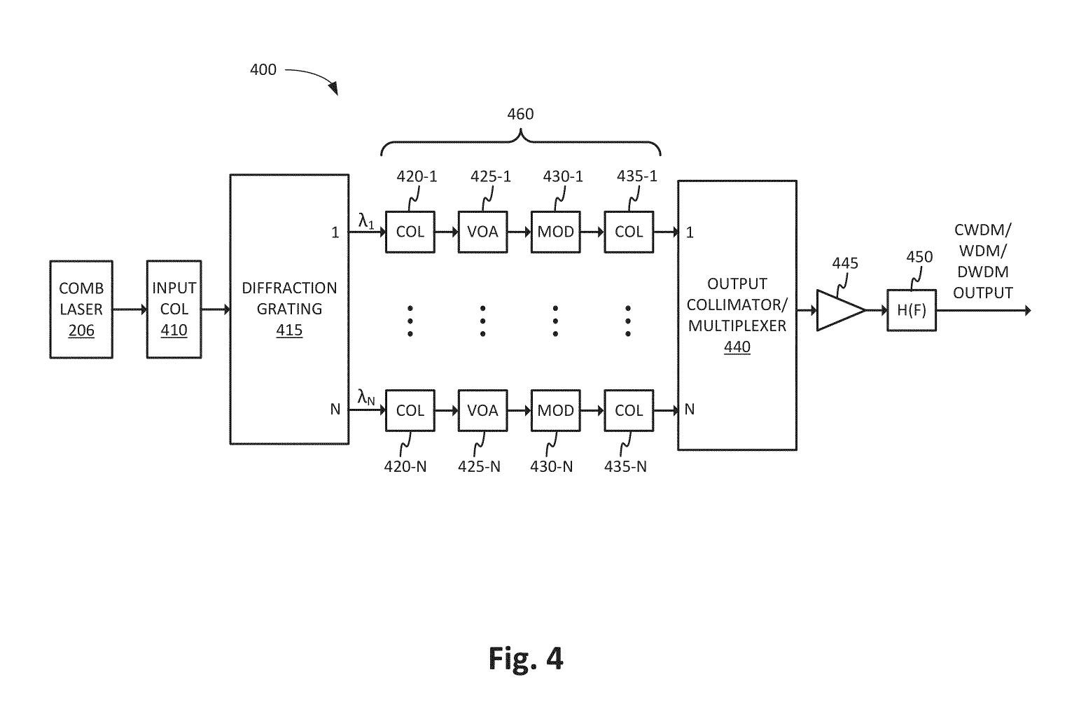

FIG. 4 is a block diagram showing exemplary components within an embodiment of Optical Tx/ROADM 400. Optical Tx/ROADM 400 may include comb laser 206, input collimator 410, diffraction grating 415, processor 460, output collimator/multiplexer 440, optical amplifier 445, and filter 450.

Processor 460 may include a plurality of optical processors, where each “leg” of processor 460 corresponds to a particular wavelength λₓ, where x=1, . . . , N, and N is the total number of wavelengths. Each leg may be thought of as a separate channel. In this embodiment, each leg corresponding to λₓ includes collimator 420-x, variable optical attenuator (VOA) 425-x, modulator 430-x, and collimator 435-x. As used herein, the components within each leg of /processor 460 may collectively be referenced without the “-x” designation. For example, the modulators across all the legs of processor 460 may be referred to as “modulators 430.” The components of Optical Tx/ROADM 400 may be configured in a manner as shown in FIG. 4 and as described below.

Further referring to FIG. 4, comb laser 206 provides a source beam having multiple wavelengths to input collimator 410. Input collimator 410 aligns the wavefronts of the source beam so they are approximately planar and properly focused. Input collimator 410 then passes the collimated source beam through diffraction grating 415, which separates the source beam into multiple beams. While not depicted in FIG. 4, diffraction grating 415 may separate the different wavelengths by scattering them at different angles. Utilizing the collimated source beam facilitates the quality of beam separation because the collimated source beam has reduced divergence, and thus the source beam will impinge on diffraction grating 415 at the desired angle. Each separated beam is centered at a particular wavelength, and thus may be regarded as a separate optical channel. For example, as shown in FIG. 4, diffraction grating 415 produces N separate beams, where each separated beam is centered at λₓ (where x=1, . . . , N). Embodiments of Optical Tx/ROADM 400 may utilize a large number of separate wavelengths, such as, for example, 150 channels (N=150). Various types of diffraction gratings may be used to separate the source beam, such as, for example, an echelle grating and/or other low loss gratings and or interleavers. Diffraction grating 415 may be optically coupled to each leg of processor 460, which is described in more detail below.

As exemplified in FIG. 4, each leg of processor 460 receives one of the N beams from diffraction grating 415 and processes the beam as a separate channel. Each separate channel x (where x=1, . . . , N) is associated with a corresponding wavelength (λₓ), and the processing of the N channels may be performed in parallel. Therefore, the N channels may be processed in a substantially simultaneous manner. However, depending upon the physical characteristics of the optical circuits and the components, the processing across all N legs may not be exactly simultaneous. Statistical variations in component values and path lengths, and/or non-ideal component characteristics (such as, for example, wavelength dependent delays and/or non-linear characteristics) may cause timing variability across the legs in processor 460 which may be compensated through further known processing techniques. For the embodiment shown in FIG. 4, aside from being assigned to different wavelengths, the legs in processor 460 may be structurally and functionally similar to each other. Accordingly, the description for each of the legs may be presented in the context of a single exemplary leg (hereinafter “Leg-x”) associated with the wavelength λₓ. However, in alternate embodiments, the legs of processor 460 may be different from one another.

Leg-x may include collimator 420-x which is optically coupled to diffraction grating 415. Collimator 420-x receives a beam centered at wavelength λₓ (hereinafter Beam-x) from diffraction grating 415, and collimates Beam-x for alignment and focus. Collimator 420-x may be optically coupled to variable optical attenuator (VOA) 425-x. In this embodiment, VOA 425-x may perform several functions. The first function of VOA 425-x includes attenuating the amplitude of Beam-x to adjust the power in Leg-x. The attenuation of particular wavelengths may be done at the request of the network (e.g., based on predetermined signal requirements). Alternatively, the amplitude of a particular wavelength may be adjusted to compensate for amplitude variations that vary with wavelength. Such variations may be introduced by some optical components in Optical Tx/ROADM 400. For example, the output of diffraction grating 415 may not be uniform across all the wavelengths X_{1-N}, and can be corrected within each leg. In another example, wavelength dependent amplitude variations may be introduced into the source beam by comb laser 206. Such amplitude variations are exemplified in graph 208 of FIG. 2, which shows an amplitude taper across the range of wavelengths A.

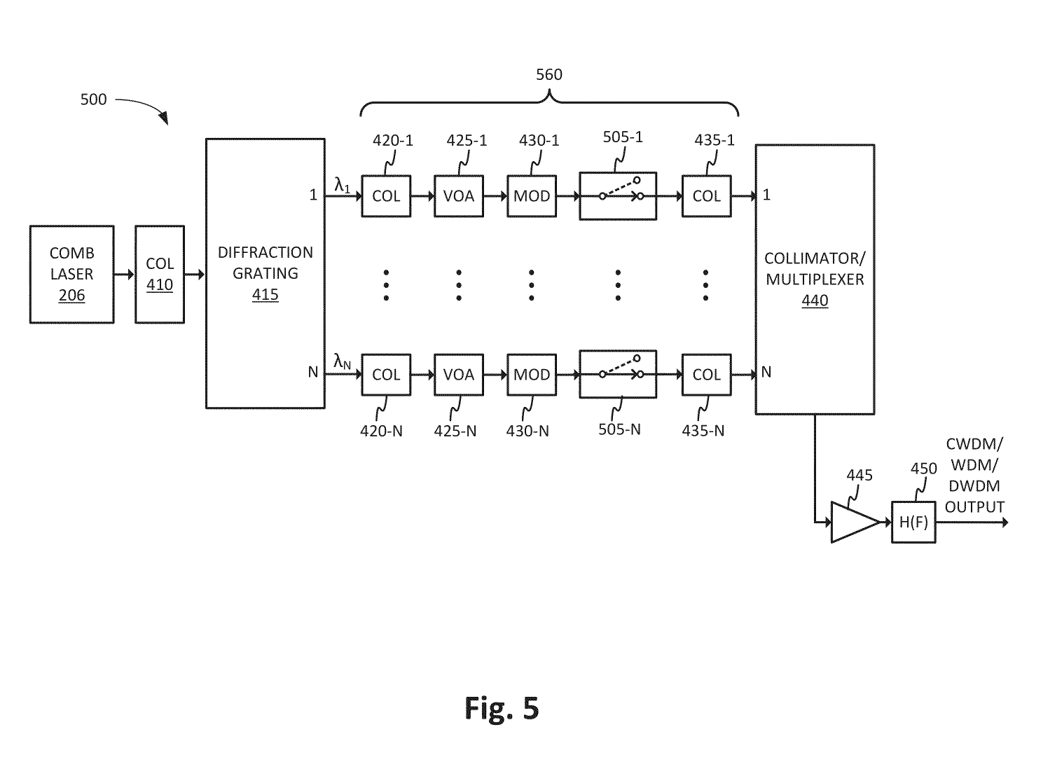

The second function that VOA 425-x may perform in this embodiment is to add or drop wavelength λₓ to accomplish ROADM functionality. Here, VOA 425-x may sharply attenuate Beam-x to a negligible amplitude in order to drop λₓ. As will be discussed in reference to FIG. 5, faster add/drop functionality can be accomplished in a different embodiment by adding an additional switch in each processing leg.

Further referring to FIG. 4, VOA 425-x is optically coupled to modulator 430-x, which modulates Beam-x to encode information therein and create a signal. Modulator 430-x may perform any type of modulation suitable for optical signals, which may include, for example, 10Gb/sec-100Gb/sec modulation formats. These formats may further use, for example On-Off Keying (00K), Quadrature Phase Shift Keying (QPSK), Differential Phase Shift Keying (DPSK), Quadrature Amplitude Modulation (QAM), or Orthogonal Frequency Division Multiplexing (OFDM) modulation techniques, or any suitable combinations thereof. Because the modulators 430 in each leg may separately modulate the beams for their corresponding wavelengths λ_{1-N}, a diverse mix of signals may be created. For this embodiment, the last component in Leg-x is collimator 435-x, which is optically coupled to modulator 430-x, and further aligns and focuses modulated Beam-x prior to combining the wavelengths λ_{1-N} as described below. In an alternative embodiment, modulators 430 may switch places with collimators 420 in the legs of processor 460. Thus, modulator 430-x may be optically coupled to diffraction grating 415 to receive Beam-x directly from diffraction grating 415. The modulated Beam-x may be provided to VOA 425-x, and then onto collimator 420-x for alignment and focus.

All of the legs corresponding to wavelengths λ_{1-N} in processor 460 may be optically coupled to output collimator/multiplexer 440, which combines all of the beams centered at wavelengths λ_{1-N} to create a combined signal. The combined signal may be a WDM or a DWDM signal, depending upon the requirements of the network. The collimator/multiplexer may be optically coupled to optical amplifier 445, which provides the combined optical signal with enough power for transmission over the network. The amplified optical signal may be further processed with gain-flattening filter 450, which is optically coupled to optical amplifier 445. The gain flattening filter 450 can compensate for any frequency alterations in the combined signal which may have been introduced by optical amplifier 445. At this point, the combined signal is ready for transmission over the optical network.

FIG. 5 is a block diagram of an embodiment of an Optical Tx/ROADM 500 illustrating exemplary components which include photonic switches 505. Optical Tx/ROADM 500 may include comb laser 206, input collimator 410, diffraction grating 415, processor 560, output collimator/multiplexer 440, optical amplifier 445, and filter 450.

Processor 560 may include a plurality of optical processors, where each leg (Leg-x) of processor 560 is a separate channel which corresponds to a particular wavelength λₓ (where x=1, . . . , N and N is the total number of wavelengths). In the embodiment shown in FIG. 5, Leg-x includes collimator 420-x, VOA 425-x, modulator 430-x, photonic switch 505-x, and collimator 435-x. Optical Tx/ROADM 500 may be configured in a manner as shown in FIG. 5 and as described below.

For brevity, elements having reference numbers which were shown in previous drawings and described above will not be described again, unless such description is relevant to the explanation of the features particular to the Optical Tx/ROADM 500 shown in FIG. 5.

In processor 560, photonic switch 505-x is added to Leg-x to provide drop/add functionality to Optical Tx/ROADM 500. The photonic switch 505-x may be placed between modulator 430-x and collimator 435-x. The photonic switch 505-x receives the modulated beam from modulator 430-x, and can drop the wavelength by switching the modulated beam out of the signal path. Wavelength λₓ can be added by having photonic switch 505-x switch the modulated beam into the signal path, so it is provided to collimator 435-1. The photonic switch may be a 1×2 switch, and may feature fast switching times (e.g., on the order of 50 μsec or less).

Moreover, in this embodiment, the VOA 425-x would not perform the drop/add functionality by changing the attenuation as described above in FIG. 4. Instead, VOA 425-x would only vary the attenuation to adjust the power of Beam-x. The photonic switch 505-1 can perform the drop/add functionality faster on the order of nanoseconds or femto seconds, and may provide higher isolation when a particular wavelength is dropped. To improve isolation of dropped wavelengths, in one embodiment, optical switches 505 may be coupled to a VOAs (not shown) to improve isolation. Thus, when a particular wavelength is dropped, it becomes “dark” over the fiber at the output.

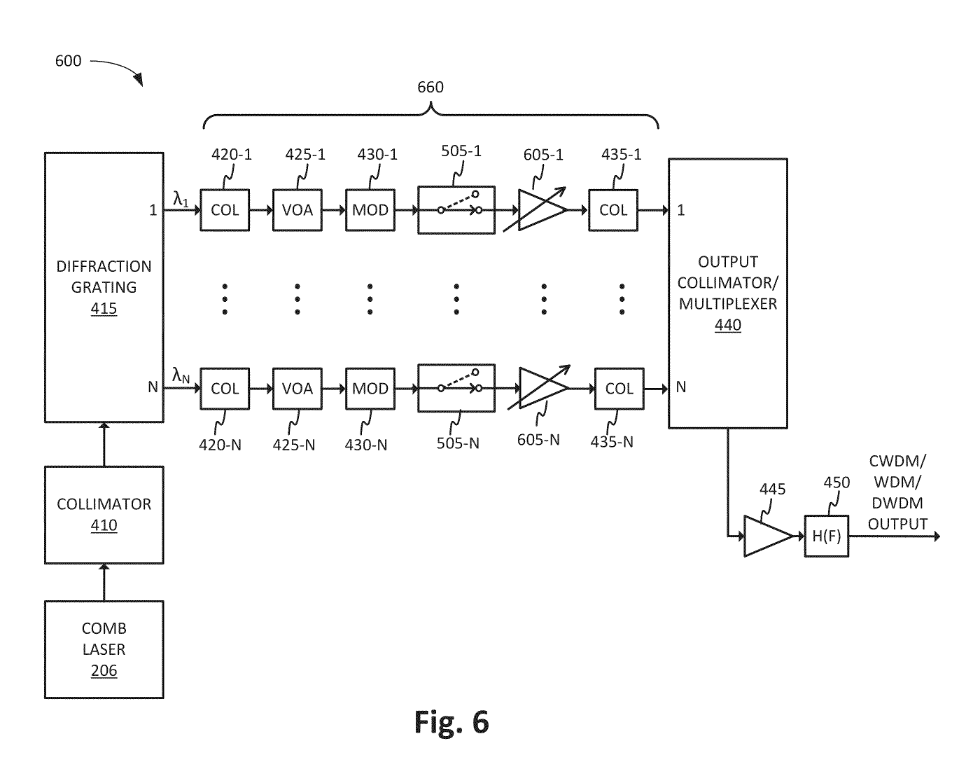

FIG. 6 is a block diagram of an embodiment of an Optical Tx/ROADM 600 illustrating exemplary components which include variable gain amplifiers. Optical Tx/ROADM 600 may include comb laser 206, input collimator 410, diffraction grating 415, processor 660, output collimator/multiplexer 440, optical amplifier 445, and filter 450.

Processor 660 may include a plurality of optical processors, where each leg (Leg-x) of processor 660 is a separate channel which corresponds to a particular wavelength λₓ (where x=1, . . . , N and N is the total number of wavelengths). In the embodiment shown in FIG. 6, Leg-x includes collimator 420-x, variable optical attenuator 425-x, modulator 430-x, photonic switch 505-x, variable optical gain amplifier 605-x, and collimator 435-x. Optical Tx/ROADM 600 may be configured in a manner as shown in FIG. 6 and as described below.

For brevity, elements having reference numbers which were shown in previous drawings and described above will not be described again, unless such description is relevant to the explanation of the features particular to the Optical Tx/ROADM 600 shown in FIG. 6.

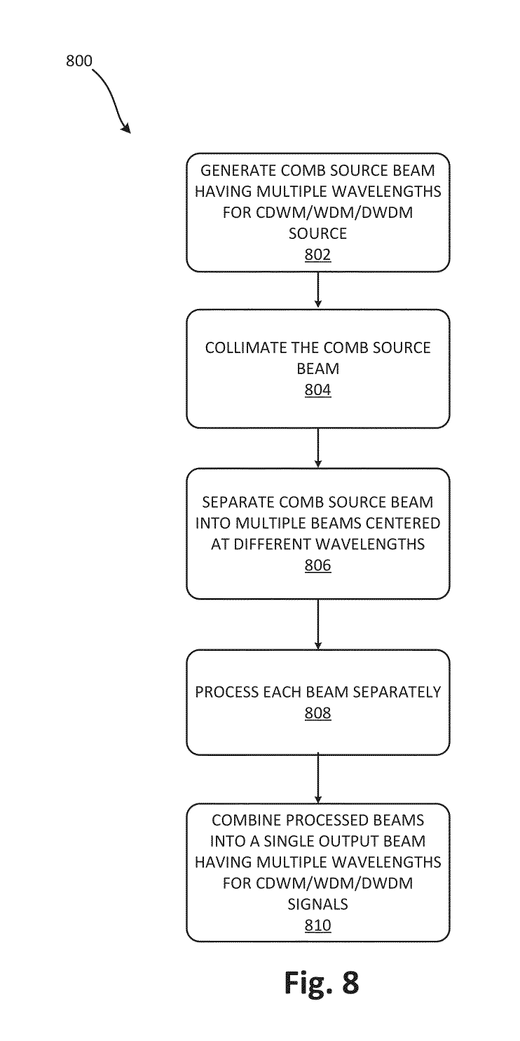

In processor 660, variable optical gain amplifier 605-x is added to Leg-x to provide optical amplification for wavelength λₓ. The variable optical gain amplifier 605-x may be placed between photonic switch 505-x and collimator 435-x. The variable optical gain amplifier 605-x receives the beam from photonic switch 505-x and provides amplification to the modulated optical beam. The amplified beam may then be provided to collimator 435-x. The gain of the variable gain optical amplifier 605-x may be adjusted based on the needs of the network for a particular wavelength λₓ. As will be discussed below in relation to FIG. 8, variable optical amplifier 605-x may be adjusted under computer control to automatically adjust the gains of Beam x.

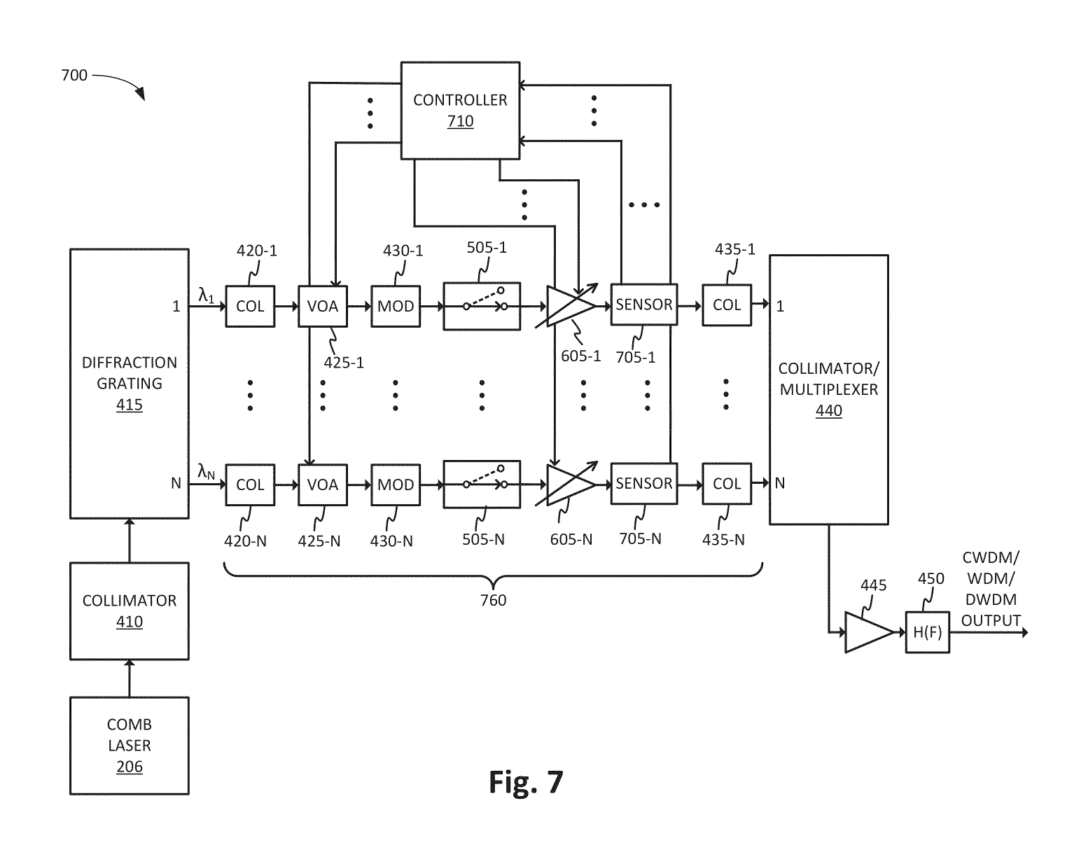

FIG. 7 is a block diagram of an embodiment of an Optical Tx/ROADM 700 illustrating exemplary components which include those used for automatic gain control. Optical Tx/ROADM 700 may include comb laser 206, input collimator 410, diffraction grating 415, processor 760, output collimator/multiplexer 440, optical amplifier 445, and filter 450.

Processor 760 may include a plurality of optical processors, where each leg (Leg-x) of processor 760 is a separate channel which corresponds to a particular wavelength λₓ (where x=1, . . . , N and N is the total number of wavelengths). In the embodiment shown in FIG. 7, Leg-x includes collimator 420-x, variable optical attenuator 425-x, modulator 430-x, photonic switch 505-x, variable optical gain amplifier 605-x, sensor 705-x, controller 710-x, and collimator 435-x. Optical Tx/ROADM 700 may be configured in a manner as shown in FIG. 7 and as described below.

For brevity, elements having reference numbers which were shown in previous drawings and described above will not be described again, unless such description is relevant to the explanation of the features particular to the Optical Tx/ROADM 700 shown in FIG. 7.

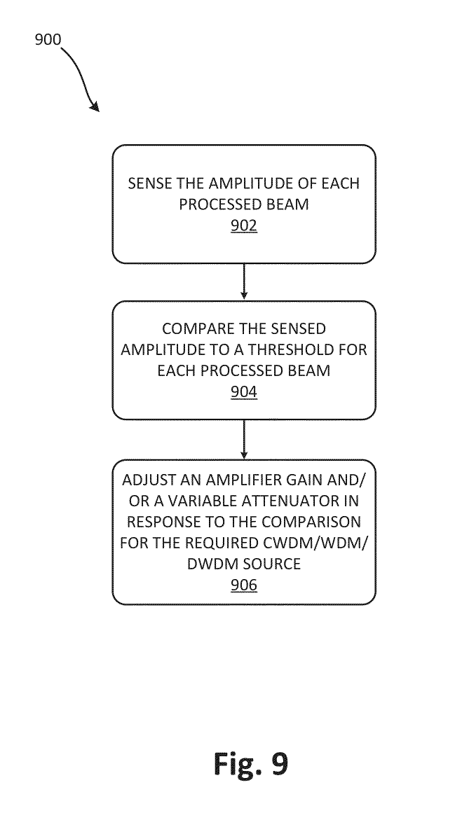

In processor 760, sensor 705-x is placed within Leg-x after variable gain amplifier 605-x to measure the amplitude of Beam-x after amplification. Sensor 705-x provides amplitude information to controller 710, so controller may change variable optical attenuator 425-x and/or variable gain amplifier 605-x to automatically control the gain of Beam-x. The controller 710 may control each leg separately by independently controlling variable optical attenuators 425 and variable gain amplifiers 605 for all the legs in processor 760. A flow chart illustrating an exemplary method for automatically controlling the gain of Beam-x is described below with respect to FIG. 9. In an alternative embodiment, the sensors 704 in processor 760 may be replaced with a single sensor (not shown), which may determine gain distribution across each leg in processor 760 using a spectrum analyzer. The outputs of the spectrum analyzer may be provided to controller 710 to facilitate the gain control in each leg by adjusting variable optical attenuators 425 and/or variable gain amplifiers 605.

While not explicitly shown in the Figures, other components in Optical Tx/ROADM 700 may be under computer control to facilitate its operation, such as, for example, diffraction grating 415, modulators 430, photonic switches 505, and/or collimator/multiplexer 440. Such control may facilitate the functionality of each of these devices as described above, and their control may be accomplished using known techniques.

FIG. 8 is a flowchart showing an exemplary method 800 for the operation of the Optical Tx/ROADM 300 of FIG. 3. Method 800 initially generates a comb source beam having a plurality of wavelengths (Block 802). This may be accomplished using comb laser 206, which generates a source beam having a range of wavelengths. Method 800 then collimates the comb source beam to align and focus the beam for better separation of the wavelengths (Block 804). The source beam is separated into a plurality of beams, where each separated beam is centered at a different wavelength λₓ (where x=1, . . . , N and N is the total number of wavelengths) (Block 806). Method 800 then processes each beam separately (Block 808), where the processing may be done in a parallel manner. Method 800 then combines the plurality of processed beams into an output beam having a plurality of wavelengths (Block 810).

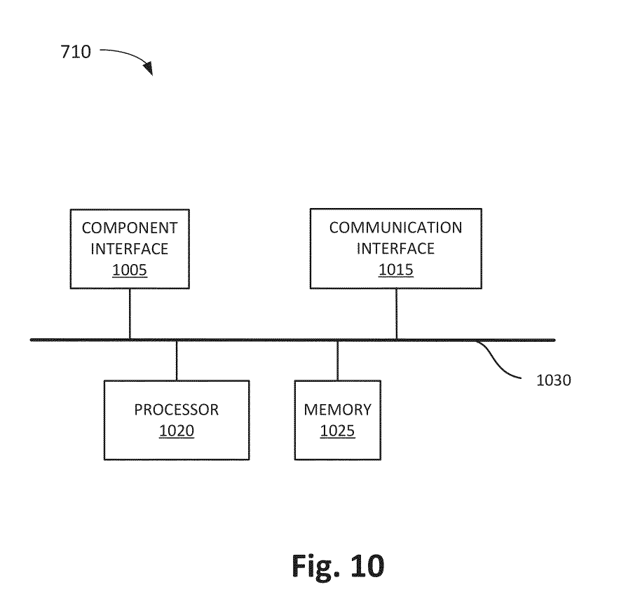

FIG. 9 is a flowchart showing an exemplary method 900 for the operation of the automatic gain control for the Optical Tx/ROADM 700. Method 900 initially senses the amplitude of the processed beam associated with each leg in processor 760 (Block 902). Method 900 then compares the sensed amplitude to a threshold for each processed beam (Block 904). Method 900 then adjusts an amplifier gain (e.g., amplifiers 605) and/or a variable attenuator (e.g., VOA 425) for each processed beam in response to the comparing (Block 906). Method 900 may be implemented in software, and executed on a controller as described below in FIG. 10.

FIG. 10 is a block diagram of an exemplary controller 710 for the Optical Tx / ROADM 700 shown in FIG. 7. As shown in FIG. 10, controller 710 may include a bus 1030, a processor 1020, a memory 1025, a sensor interface 1005, an output interface 1010, and communication interface 1015.

Bus 1030 includes path that permits communication among the components of controller 710. Processor 1020 may include any type of single-core processor, multi-core processor, microprocessor, latch-based processor, and/or processing logic (or families of processors, microprocessors, and/or processing logics) that interprets and executes instructions. In other embodiments, processor 1020 may include an Application Specific Integrated Circuit (ASIC), a Field Programmable Gate Array (FPGA), and/or another type of integrated circuit or processing logic.

Memory 1025 stores information, data, and/or instructions which include code for the configuration assistant. Memory 1025 may include a dynamic, volatile, and/or non-volatile storage device. Memory 1025 may store instructions, for execution by processor 1020, or information for use by processor 1020. For example, memory 1025 may include a RAM, a ROM, a CAM, a magnetic and/or optical recording memory device, etc.

Component interface 1005 permits processor 1020 to interact with various components in controller 710. For example, component interface 1005 permits the processor 1020 to receive information from sensors 705 regarding the amplitude of the beams in each leg of processor 760. Component interface 1005 further permits controller 710 to issue commands to variable gain amplifiers 605 and variable optical attenuators 425 to control the gains in each leg based on the inputs received from sensors 705 and method 900. Communication interface 1015 may include (e.g., a transmitter and/or a receiver) that enables controller 710 to communicate administration and control data devices and/or systems.

Controller 710 may perform operations relating to the automatic gain control of the beams associated with each leg in processor 760. Controller 710 may perform these operations in response to processor 1020 executing software instructions contained in a computer-readable medium, such as memory 1025. The software instructions contained in memory 1025 may cause processor 620 to perform the operations, such as, for example, those relating to process 900.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while series of blocks have been described with respect to FIGS. 8 and 9, the order of the blocks and/or signal flows may be modified in other implementations. Further, non-dependent blocks and/or signal flows may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code--it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

The terms “comprises” and/or “comprising,” as used herein specify the presence of stated features, integers, steps or components but does not preclude the presence or addition of one or more other features, integers, steps, components, or groups thereof. Further, the term “exemplary” (e.g., “exemplary embodiment,” “exemplary configuration,” etc.) means “as an example” and does not mean “preferred,” “best,” or likewise.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A device, comprising:
a comb laser to provide a source beam having a plurality of wavelengths;
a wavelength separator, coupled to the comb laser, to create a plurality of beams from the source beam, wherein each beam from the plurality of beams is centered at a different wavelength;
a plurality of processors, each coupled to the wavelength separator, to separately process each beam; and
a wavelength combiner, coupled to the plurality of processors, to merge the plurality of beams into an output beam having a plurality of wavelengths.

2. The device of claim 1, further comprising:
a preprocessor, coupled to the comb laser and the wavelength separator, to condition the beam for separating the wavelengths.

3. The device of claim 2, wherein the preprocessor further comprises an input collimator.

4. The device of claim 1, wherein the wavelength separator comprises a diffraction grating.

5. The device of claim 4, wherein each processor of the plurality of processors is associated with a different particular wavelength, each processor further comprising:
a first collimator coupled to the diffraction grating;
a variable optical attenuator coupled to the collimator;
a modulator coupled to the variable optical attenuator; and
a second collimator coupled to the modulator.

6. The device of claim 5, further comprising:
an optical switch, coupled to the modulator and the second collimator, to add or drop a beam having a particular wavelength to or from the output beam.

7. The device of claim 6, further comprising:
a variable gain optical amplifier, coupled to the second collimator, to adjust the gain of a beam having a particular wavelength.

8. The device of claim 7, further comprising:
a sensor, coupled to the variable gain optical amplifier, to measure the amplitude of the beam having a particular wavelength; and
a controller, coupled to at least one of the optical variable gain amplifier, or the variable optical attenuator, and further coupled to the sensor, to control the amplitude of the beam based on the measurement by the sensor.

9. The device of claim 5, wherein the wavelength combiner comprises:
an output collimator coupled to the second collimator of each processor; and
a multiplexer coupled to the second collimator.

10. The device of claim 6 further comprises:
an optical amplifier coupled to the multiplexer; and
a gain flattening filter coupled to the optical amplifier.

11. The device of claim 1, wherein the output beam having a plurality of wavelengths is a Dense Wavelength Division Multiplexed (DWDM) optical signal.

12. The device of claim 1, wherein the plurality of wavelengths are in at least one of C-band or L-band.

13. A device, comprising:
a comb laser to provide a source beam having a plurality of wavelengths;
an input collimator, coupled to the comb laser, to condition the source beam for separating the wavelengths;
a diffraction grating, coupled to the input collimator, to create a plurality of beams from the source beam, wherein each beam is centered at a different wavelength;
a plurality of processors, each being coupled to the diffraction grating, to separately process each beam from the plurality of beams, each processor further comprising:
a first collimator coupled to the diffraction grating;
a variable optical attenuator coupled to the collimator;
a modulator coupled to the variable optical attenuator; and
a second collimator coupled to the modulator;
an output collimator coupled to the second collimator of each processor; and
a multiplexer coupled to the second collimator to provide an output beam having a plurality of wavelengths.

14. The device of claim 13, further comprising:
an optical switch, coupled to the modulator and the second collimator, to add/drop a beam having a particular wavelength to/from the output beam.

15. The device of claim 13, further comprising:
a variable gain optical amplifier, coupled to the second collimator, to adjust the gain of a beam having a particular wavelength.

16. The device of claim 15, further comprising:
a sensor, coupled to the variable gain optical amplifier, to measure the amplitude of the beam having a particular wavelength; and
a controller, coupled to at least one of the optical variable gain amplifier, or the variable optical attenuator, and further coupled to the sensor, to control the amplitude of the beam based on the measurement by the sensor.

17. The device of claim 13 further comprising:
an optical amplifier coupled to the multiplexer; and
a gain flattening filter coupled to the optical amplifier.

18. The device of claim 13, wherein the output beam having a plurality of wavelengths is a Dense Wavelength Division Multiplexed (DWDM) optical signal.

19. A method, comprising:
generating a comb source beam having a plurality of wavelengths;
collimating the comb source beam;
separating the comb source beam into a plurality of beams, wherein each separated beam is centered at a different wavelength;
processing each beam from the plurality of beams separately; and
combining the plurality of processed beams into an output beam having a plurality of wavelengths.

20. The method of 19, further comprising:
sensing the amplitude of each processed beam;
comparing the sensed amplitude to a threshold for each processed beam; and
adjusting at least one of an amplifier gain, or a variable attenuator for each processed beam in based on to the comparing.
